(19) United States
(12) Patent Application Publication
(10) Pub. No.: US 2024/0101720 A1
(43) Pub. Date: Mar. 28, 2024

(54) SINGLE-USE PLASTIC PRODUCTION FOR PACKAGING VIA UPCYCLING OF FOOD WASTE

(71) Applicant: UCHICAGO ARGONNE, LLC, Chicago, IL (US)

(72) Inventors: Meltem Urgun Demirtas, Naperville, IL (US); Chaoyi Ba, Schaumburg, IL (US)

(21) Appl. No.: 18/372,969

(22) Filed: Sep. 26, 2023

Related U.S. Application Data
(60) Provisional application No. 63/410,462, filed on Sep. 27, 2022.

(51) Int. Cl. C08B 37/08; B29C 39/00; C08J 5/18

(52) U.S. Cl. CPC C08B 37/003; B29C 39/003; C08J 5/18; B29K 2005/00; C08J 2305/08

(57) ABSTRACT

A method of forming a plastic component can includes treating a polysaccharide source with an acid solution under conditions sufficient to extract the starch from the polysaccharide source, wherein the polysaccharide precipitates in the acid solution; separating the precipitate from the acid solution; drying the separated precipitate; admixing the dried precipitate with water to form a slurry; and casting or molding the slurry to form the plastic component.

### CROSS-REFERENCE TO RELATED APPLICATION

The benefit of priority to U.S. Provisional Patent Application No. 63/410,462 filed Sep. 27, 2022, is hereby claimed and the disclosure is incorporated herein by reference in its entirety.

### STATEMENT OF GOVERNMENT SUPPORT

This invention was made with government support under Contract No. DE-AC02-06CH11357 awarded by the United States Department of Energy to UChicago Argonne, LLC, operator of Argonne National Laboratory. The government has certain rights in the invention.

### FIELD

The disclosure is directed to methods for making single-use plastic using polysaccharide sources such as food products and food waste.

### BACKGROUND

Plastic usage and waste constitute a growing problem for the world, as most of the 300 million tons of plastic produced annually come from unsustainable fossil resources and pose environmental concerns due to their persistence in the environment (US EPA, 2021). Within the United States (US) only a small fraction (approximately 9%) of plastics are recycled (US EPA, 2021). The remaining materials are usually landfilled, incinerated, or in some cases discarded, where they eventually make their way into marine environments (Geyer et al., 2017). The US Environmental Protection Agency (EPA) recently reported that approximately 76% of the 32 million tons of plastics generated in 2018 were landfilled (US EPA, 2021).

A recent estimate of global food waste made by the FAO was 1.3 billion tons in 2007 (FAO, 2013). Furthermore, US EPA estimates that approximately 57.3 million tons of food waste was generated in 2018, with 56% disposed of in landfills (US EPA, 2021). In landfills, food waste produces significant amounts of methane emissions, contributing to global warming and climate change. Opportunities exist to reduce both plastic and food waste by employing commonly wasted foods as feedstocks to produce plastic materials. This is particularly true for single-use plastics (e.g., meat packaging, candy wrappers, etc.) as many current materials (e.g., high-density and low-density polyethylene) are designed to be thrown away immediately yet persist in the environment for extremely long time periods (Ward et al., 2020).

Many prior studies have synthesized polymer films from food or food waste sources (e.g., potato starch and chitosan), as well as fruit and vegetable purees, (e.g., bananas, apples, and carrots) as feedstocks to make prototype polymer films (Martelli et al., 2013; McHugh et al., 1996; Rojas-Graü et al., 2006; Wang et al., 2011). Of particular interest are banana and potato feedstocks, since large amounts of these foods are wasted yearly in the US (over 360 thousand tons of potatoes and over 130 thousand tons of bananas, respectively) and both contain large amounts of film-forming materials such as starch (Cordenunsi-Lysenko et al., 2019; Robertson et al., 2018; USDA, 2020).

Chitosan is a widely known polymer produced via the deacetylation of chitin, and it has been the subject of large amounts of research due its film-forming ability, biodegradability, and solubility (Mujtaba et al., 2019). Chitin, the second most abundant naturally occurring polymer, is primarily obtained via the shell waste of various crustaceans from the commercial fishing industry (Pighinelli et al., 2019). Therefore, chitosan is another attractive material to address both food waste and plastic pollution, as it is produced from a naturally occurring material that is itself obtained via the utilization of waste streams from seafood production. Prior studies have used chitosan as an additive for films made from banana puree (Martelli et al., 2013), papaya puree (de Barros-Alexandrino et al., 2019), as well as other bioderived materials such as pectin and fish gelatin (Hosseini et al., 2015; Melo et al., 2019). However, most of these studies focus on using chitosan as a nanoparticle and in relatively low concentration (0.1-0.3% w/w), rather than as a principal film-forming agent in film formulations.

Blend films of chitosan with commercially available starch has been widely reported (Cazon et al., 2020; Haghighi et al., 2020; Priyadarshi et al., 2020). The blend films of different ratio of chitosan and commercially available corn starch was studied and 1:1 w/w of chitosan/corn starch was reported to be the optimal ratio (Xu et al., 2005). Choo et al. utilized acetylated chitosan to produce blend films with potato starch and different essential oils. (Choo et al., 2021). Blend films of chitosan with commercially available potato starch with additional crosslinkers such as citric acid and ferulic acid were also reported (Matthew et al., 2008; Wu et al., 2019). Chitosan/banana flour blend film was reported by Pitak et al. (Pitak et al., 2011). These chitosan starch blend films showed great antibacterial activity and improved water vapor permeation properties, but poorer mechanical properties (low elongation at break of 1-25%).

### SUMMARY

A method of forming a plastic component in accordance with the disclosure can include treating a polysaccharide source with an acid solution under conditions sufficient to extract the polysaccharide from the polysaccharide source, wherein the polysaccharide precipitates in the acid solution; separating the precipitate from the acid solution; drying the separated precipitate; and mixing the dried precipitate with water to form a slurry; and casting or molding the slurry to form the plastic component. For example, the polysaccharide source can be a starch source.

A method of forming a plastic compound in accordance with the disclosure can include treating a first polysaccharide source with an acid solution under conditions sufficient to extract the polysaccharide from the polysaccharide source, wherein the polysaccharide precipitates in the acid solution as a first precipitate; separating the first precipitate from the acid solution; drying the separated first precipitate; treating a second polysaccharide source with an acid solution under conditions sufficient to extract the polysaccharide from the second polysaccharide source, wherein the polysaccharide precipitates in the acid solution as a second precipitate; separating the second precipitate from the acid solution; drying the separated second precipitate; admixing the dried first and second precipitates with water to form a slurry; and casting or molding the slurry to form the plastic component. The first and/or second polysaccharide source can be, for example, a starch source. The first and/or second polysaccharide source can be, for example, an amino polysaccharide. The amino polysaccharide can be for example Chitosan.

Methods of the disclosure can advantageously provide a one-pot method for casting a plastic component from biodegradable and sustainable feedstocks obtained with mild synthesis conditions from organic waste streams.

Methods of the disclosure can further include coating the formed plastic components with a biodegradable barrier layer to improve water vapor transmission properties without changing its mechanical properties and biodegradability.

### BRIEF DESCRIPTION OF THE DRAWINGS

FIG. 1A is a graph showing maximum stress of conventional chitosan films and films made by methods of the disclosure. Bars represent standard error;

FIG. 1B is a graph showing maximum elongation of conventional chitosan films and films made by methods of the disclosure. Bars represent standard error;

FIG. 2A is a graph of water vapor transmission rates (WVTR) of conventional chitosan films and films made by methods of the disclosure. Bars represent standard error;

FIG. 2B is a graph of water vapor permeability (WVP) of conventional chitosan films and films made by methods of the disclosure. Bars represent standard error;

FIG. 3 is a FTIR spectral of chitosan films and banana-starch source films made by methods of the disclosure;

FIG. 4 is a FTIR spectral of chitosan films and potato-starch source films made by methods of the disclosure;

FIGS. 5A-5E are scanning electron microscopy images of film cross-sections of (A) Chitosan film; (B) Banana-starch source film of the disclosure; (C) Potato-starch source film of the disclosure; (D) Banana-starch source and chitosan blend film of the disclosure; and (E) Potato-starch source and chitosan blend film of the disclosure;

FIG. 6 is a graph of TGA thermograms of the films of FIGS. 5A-5E;

FIG. 7A is a graph of DSC full thermograms of chitosan film, banana-starch source film of the disclosure, potato-starch source film of the disclosure; banana-starch source and chitosan blend film of the disclosure; and potato-starch source and chitosan blend film of the disclosure;

FIG. 7B is the thermogram of FIG. 7A, showing thermograms from 10° C. to 80° C. showing the glass transition temperatures (T_{g});

FIG. 8 is a graph of XRD diffractograms of chitosan film, banana-starch source film of the disclosure, potato-starch source film of the disclosure; banana-starch source and chitosan blend film of the disclosure; and potato-starch source and chitosan blend film of the disclosure;

FIG. 9 is a schematic illustration of a film formed in accordance with the disclosure having a water-vapor barrier layer;

FIG. 10 includes SEM images of PHB-20-A1C2 with a zoomed scale of 600× (left) and 2350× (right);

FIG. 11 shows the results of transparency testing of PHB-laminated PC films formed in accordance with the disclosure showing that transparency increased with increasing acetic acid;

FIG. 12 is an XRD diffractogram of a PHB film and PHB-laminated PC films formed in accordance with the disclosure using different ratios of acetic acid and chloroform as solvents;

FIG. 13 is a schematic illustration of a method in accordance with the disclosure; and

FIG. 14 includes images of a pilot scale run of a method in accordance with the disclosure to scale up biofilm synthesis production process by using a pilot-scale cast machine used by the industry.

### DETAILED DESCRIPTION

Methods of the disclosure beneficially provide for the production of plastic using widely available polysaccharide sources, such as food and food waste, as the starting material as opposed to commercially available starch. The plastics produced by the methods of the disclosure can be plastic films. For example, the methods of the disclosure can be used to produce biodegradable polymer blend films with an amino polysaccharide, such as chitosan. The films produced by the methods of the disclosure can be useful, for example, in single use packaging applications.

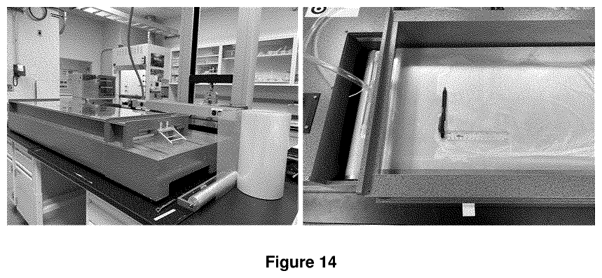

Methods of the disclosure include treating a polysaccharide source with an acid solution and mixing to extract the polysaccharide from the polysaccharide source and form a precipitate. The precipitate is removed from the solution and then dried. The dried precipitate can be ground. The dried precipitate is then mixed with water to form a slurry, which can be cast, molded, or otherwise used to form a plastic component. For example, the plastic component can be a plastic sheet or film. The method can include using two or more dried precipitates in combination. For example, two polysaccharide sources, first and second polysaccharide sources, can be independently treated with an acid solution to form first and second precipitates directly. The first and second precipitates can be dried and then combined with water to form the slurry. Alternatively, two or more polysaccharide sources can be treated with the acid solution in combination to form a mixed precipitate, which is then mixed with water to form the slurry. FIG. 13 is a schematic illustration of a method in accordance with the disclosure. FIG. 14 shows the method of the disclosure in a pilot scale run to scale up the one pot biofilms synthesis process from lab scale to pilot-scale using a casting machine used by the industry for scale up.

Referring to FIG. 9, the methods of the disclosure can further include applying a biodegradable barrier layer to the surface of the formed biodegradable plastic component. The biodegradable barrier layer can be applied, for example, by dissolving the biodegradable barrier layer material in a solvent or a solvent mixture and applying to the surface of the plastic component. For example, the dissolved barrier layer material can be cast, dip coated, spray coated, or applied using any other known application methods to the plastic component. It was observed that the lamination of the biodegradable barrier layer significantly improved water vapor barrier properties of the biodegradable plastic component, for example, improving water vapor barrier properties of a film by 85% compared to the uncoated film. The bilayer components and films formed in accordance with the methods of the disclosure also demonstrated excellent transparency.

The polysaccharide source can be from food and/or food waste. For example, the polysaccharide source can be a starch source. The polysaccharide source can be obtained from food and/or food waste. For example, the food and/or food waste can be starch containing grains, fruits, and vegetables. For example, the polysaccharide source can be a food and/or food waste product having at least about 10% by weight polysaccharide based on the total weight of the food/food waste product on a dry basis. For example, the food and/or food waste product can have about 10wt % to about 80wt %, about 12wt % to about 80wt %, about 15wt % to about 45wt %, about 30wt % to about 70wt %, or about 25wt % to about 75wt % polysaccharide based on the total weight of the food/food waste product on a dry basis. Other suitable amounts of polysaccharide in the polysaccharide source can be about 10, 12, 15, 20, 25, 30, 35, 40, 45, 50, 55, 60, 65, 70, 75, or 80wt % starch on a dry basis, including any ranges defined by such values and any values there between.

For example, the starch source can be a food and/or food waste product having at least about 10% by weight starch based on the total weight of the food/food waste product on a dry basis. For example, the food and/or food waste product can have about 10wt % to about 80wt %, about 12wt % to about 80wt %, about 15wt % to about 45wt %, about 30wt % to about 70wt %, or about 25wt % to about 75wt % starch based on the total weight of the food/food waste product on a dry basis. Other suitable amounts of starch in the starch source can be about 10, 12, 15, 20, 25, 30, 35, 40, 45, 50, 55, 60, 65, 70, 75, or 80% starch on a dry basis, including any ranges defined by such values and any values there between.

For example, the food and/or food waste can include one or more of banana, potatoes, rice, wheat, corn, and peas. For example, when using food and/or food waste having a peel, the peel can be removed before treating the polysaccharide source with the acid solution. The polysaccharide source can be cut into reduced size pieces before treatment.

Treating the polysaccharide source with the acid solution provides for extraction of the polysaccharides from the polysaccharide source, which can be, for example, a starch-rich food item. The polysaccharide source is mixed with the acid solution under conditions to precipitate the polysaccharides. For example, the polysaccharide solution can be mixed with the acid solution and then ground to form a suspension of the polysaccharide source in the acid solution.

The suspension can be stored for formation of the precipitates. For example, the suspension can be stored at a temperature of about 5° C. to about 10° C., about 5° C. to about 8° C., or about 4° C. to about 7° C. Other suitable temperatures can be about 4, 5, 6, 7, 8, 9, and 10° C., including any ranges defined by such values and any values there between. The suspension can be stored for about 5 hours to about 24 hours, about 10 hours to about 20 hours, about 7 hours to about 10 hours, or about 8 hours to about 18 hours. Other suitable times include about 5, 6, 7, 8, 9, 10, 11, 12, 13, 14, 15, 16, 17, 18, 19, 20, 21, 22, 23, or 24 hours; including any ranges defined by such values and any values there between. For example, the suspension can be stored for formation of precipitates at 5° C. for about 5 to about 24 hours. The precipitate can then be separated from the suspension. For example, the precipitate can be separated out by centrifugation.

The acid solution can be, for example, inorganic and/or organic acids. Examples of organic acids include acetic acid, citric acid, and lactic acids. Examples of inorganic acids include phosphoric acid and hydrochloric acid. The acid solution can be a single acid or can include a mixture of acids. The acid solution can be mixed with the polysaccharide source in an amount of about 1% w/v to about 50% w/v, about 10% w/v to about 30% w/v, about 5% w/v to about 20% w/v, or about 8% w/v to about 40% w/v based on the total weight of the mixture. Other suitable amounts of polysaccharide source to be mixed with the acid solution can be, based on the total volume of the mixture, about 1, 5, 10, 15, 20, 25, 30, 35, 40, 45, or 50% w/v; including any ranges defined by such values and any values there between.

The precipitate isolated from the acid suspension can then be dried. For example, the precipitate can be dried at about 25° C. to about 50° C., about 30° C. to about 50° C., or about 27° C. to about 40° C. Other suitable temperatures include, for example, about 25, 26, 27, 28, 29, 30, 31, 32, 33, 34, 35, 36, 37, 38, 39, 40, 41, 42, 43, 44, 45, 46, 47, 48, 49 or 50° C.; including any ranges defined by such values and any values there between. The drying time can be about 5 hours to about 24 hours, about 10 hours to about 20 hours, about 7 hours to about 10 hours, or about 8 hours to about 18 hours. Other suitable times include about 5, 6, 7, 8, 9, 10, 11, 12, 13, 14, 15, 16, 17, 18, 19, 20, 21, 22, 23, or 24 hours; including any ranges defined by such values and any values there between. The resulting dried precipitate can be ground to a powder.

The dried precipitate is mixed with water to form a slurry for plastic formation. The slurry can be an about 1% to about 10%, about 3% to about 5%, or about 4 to about 8% w/v solution of precipitate to water. Other suitable values based on w/v include, for example, 1, 2, 3, 4, 5, 6, 7, 8, 9, or 10%, including any ranges defined by such values and any values there between.

The dried precipitate can include a combination of polysaccharide sources. Where a blended of polysaccharide sources is used, the polysaccharide sources can be treated with the acid solution simultaneously or can be separately treated with the acid solution and the resulting dried precipitates can be mixed before forming the slurry or when forming the slurry.

The slurry can further include additives, such as, but not limited to plasticizers, curing agents, foaming agents, colorants, fillers, and reinforcing agents. For example, a plasticizer can be added to the slurry. For example, the plasticizer can be glycerol, glycerol triesters, polyglycerols, vegetable oils, such as soybean oil or palm oil, and derivatives thereof, and combinations thereof. The plasticizer can be added in an amount 10% w/v to about 70% w/v, about 30% w/v to about 50% w/v about 10% w/v to about 40% w/v or about 25% w/v to about 65% w/v, based on the total volume of the slurry. Other suitable amounts of plasticizer based on the total volume of the slurry include, about 10, 12, 14, 16, 18, 20, 22, 24, 26, 28, 30, 32, 34, 36, 38, 40, 42, 44, 46, 48, 50, 52, 54, 56, 58, 60, 62, 64, 66, 68, or 70% w/v; including any ranges defined by such values and any values there between.

The slurry can be further mixed with an amino polysaccharide solution before casting to produce a blended film. Amino polysaccharide solutions can be chitosan solutions, for example extracted from shrimp shells. For example, chitosan solution can be formed, for example, by dissolving chitosan powder in a solvent. The solvent can be inorganic and/or organic acids. Examples of organic acids include acetic acid, citric acid, and lactic acids. Examples of inorganic acids include phosphoric acid and hydrochloric acid. The acid solution can be a single acid or can include a mixture of acids. For example, the chitosan solution can be prepared as a 3% w/v solution by dissolving chitosan powder in 1% acetic acid. In forming the blended film, the polysaccharide can be present in the slurry in an amount of about 1% w/v to about 70% w/v, about 5% w/v to about 60% w/v, about 10% w/v to about 55% w/v, or about 5% w/v to about 25% w/v based on the total volume of the slurry. Other suitable amounts of polysaccharide based on the total volume of the slurry includes about 1, 5, 10, 15, 20, 25, 30, 35, 40, 45, 50, 55, 60, 65, or 70% w/v; including any ranges defined by such values and any values there between.

The biodegradable barrier layer can be or can include any one or more of poly(butylene succinate), collagen, polylactide, poly(caprolactone), polyglycolide, starch, cellulose, wheat gluten, and poly(3-hydroxybutyrate).

The solvent for applying the biodegradable barrier layer can be, for example, acetic acid, formic acid, propionic acid, and/or chloroform. For example, the solvent can be a mixture of acetic acid and chloroform. The mixture can include, for example, a ratio of acetic acid:chloroform of about 1:1 to about 1:5 by olume. It was observed that acetic acid served as an adhesive between the barrier layer material and the underlying biodegradable plastic compound. Referring to FIG. 11, it was observed that using a solvent with higher acetic acids amounts improved film transparency of the barrier layer coated films. The biodegradable barrier layer can be, for example, a layer of polyester, such as for example, poly(3-hydroxybutyrate) applied with a solvent mixture including acetic acid and chloroform.

Blended films of the disclosure were observed to be biodegradable. Chitosan blended films were found to be biodegradable, achieving 50-55% biodegradation in freshwater (in about 91 days), 100% biodegradation in soil (in about 45 days), and 50% biodegradation in compost (in about 45 days).

### EXAMPLES

### Extraction Method

Extraction followed a modified procedure from Martelli et al. (2013), wherein store-bought bananas and potatoes (Jewel-Osco, Darien, IL) were peeled and subsequently cut into small pieces. The pieces were mixed with 10 mM citric acid in a 1:1 w/w ratio, after which the mixture was ground in a Waring Commercial Torq 2.0 2-HP blender (Torrington, CT, USA) for approximately 2 minutes. The suspension was stored at 5° C. overnight, after which it was centrifuged in a Thermo IEC Centra CL3R benchtop centrifuge (Thermo Fisher Scientific, Waltham, MA, USA) at 3300 RPM for 1 hour. The precipitate was removed from the centrifuge cup and dried at 40° C. overnight. The precipitate was ground in the blender for 2 minutes and stored at 5° C. until use.

### Film Preparation

Banana extract slurry (BS) and potato extract slurry (PS) were individually mixed with distilled water to make 3% w/v solutions. The solutions were covered with aluminum foil and stirred for 1 hour at 600 rpm and 70° C. After 1 hour, the solutions were allowed to cool down to room temperature (20-23° C.). Parts of the solutions were used to cast BS and PS films, where 25% glycerol (Sigma-Aldrich, St. Louis, MO, USA, 99.5%) by dry weight of extract was added. Then, the solution was stirred for 30 mins, filtered with cheesecloth, and cast into petri dishes (30 g per dish). The remaining solution for both the BS and PS formulations were used to make composite chitosan-extract slurry solutions.

Chitosan solutions (3% w/v) were prepared by dissolving chitosan powder (Alfa Aesar, Haverhill, MA, USA, 85% DA) in 1% acetic acid (Sigma-Aldrich, St. Louis, MO, USA, 99%) and stirring the solution at 400 rpm and room temperature for 2 hours. One part of the chitosan solution was used to cast chitosan films, where 25% glycerol by dry weight of chitosan was added and the solution was stirred for 30 mins, filtered with cheesecloth, and cast into petri dishes (30 g per dish).

To prepare the blend films, glycerol (25% by dry weight of extracts and chitosan; the mass of the chitosan added in a later step equal to the extracts) was then added to each of the remaining BS/PS solutions. The solutions were stirred for an additional 30 mins at 800 rpm and room temperature. Next, the remaining 3% chitosan solution was added in a 1:1 ratio by mass to each of the remaining PS and BS solutions containing glycerol, effectively creating solutions of blended polymer materials: potato slurry—chitosan (PC), and banana slurry—chitosan (BC). The glycerol-plasticized PC and BC solutions were stirred for an additional 1 hour at 800 rpm and room temperature, after which they were filtered with cheesecloth and subsequently cast in 15 mm diameter petri dishes (VWR International, Radnor, PA, USA). The films were left in a fume hood to dry overnight. A summary of the film formulations is given in Table 1.

TABLE 1
Summary of tested film formulations. All films
contain a 4:1 w/w ratio of film-forming
material (polymer + extract) to glycerol.

| | Chitosan Conc. | Extract Conc. |
|---|---|---|
| Film | (% w/v) | (% w/v) |
| Chitosan | 3 | 0 |
| BS | 0 | 3 |
| PS | 0 | 3 |
| BC | 1.5 | 1.5 |
| PC | 1.5 | 1.5 |

### Film Thickness Measurements

Film thickness was measured using a digital micrometer (iGaging, San Clemente, CA, USA). Individual measurements were taken to the nearest mm, and the thickness used in any calculations was the average of 5 measurements taken at random areas of the film. Additional thickness measurements were also conducted for both the mechanical properties and water vapor transmission rate testing.

### Mechanical Properties

Maximum stress and maximum elongation of films were measured via a universal testing machine (Test Resources Inc., Shakopee, MN) according to a modified version of ASTM Standard Method D882-18 (ASTM, 2018). Films were cut into 1 in.×2.5 in. rectangular strips and stored at 23° C. and 50% RH in an environmentally controlled oven (HPP 260, Memmert USA, Eagle, WI, USA) for at least 12 hours prior to testing. Initial grip separation was set at 0.5 in. and crosshead speed was 1 in/min. In this test, max stress (MPa) is defined as the maximum stress before film breaking and was calculated by dividing the max load by the initial cross-sectional area of the film sample. Max elongation (%) is as the maximum elongation of the film before breaking. All reported measurement values were the average of 5 replicates.

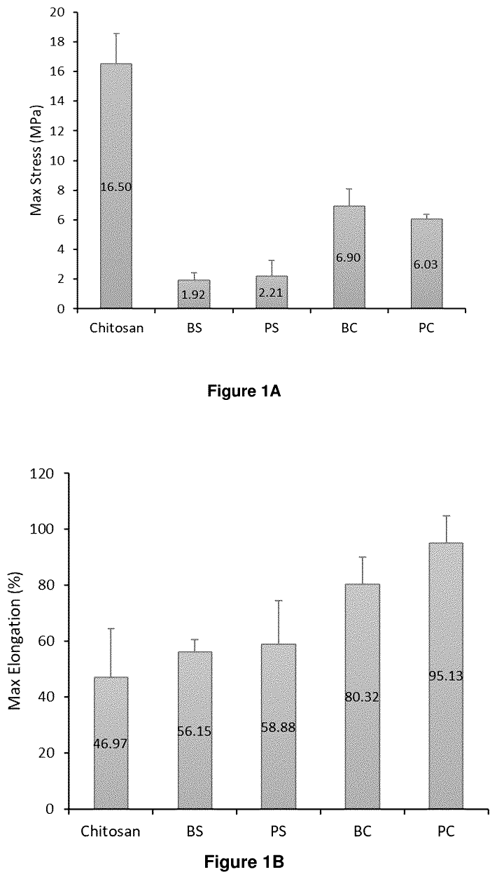

The max stress and max elongation of extract films, chitosan, and blend films were tested, and the results are shown in FIG. 1. For the max stress of films, the chitosan film showed the highest stress (16.50±2.08 MPa). The extract films BS and PS showed the lowest max stresses at 1.92±0.52 and 2.21±1.07 MPa, respectively. Blending of the food extracts with chitosan produced increases in max stress for both the BC and PC blend films vs the original extract films BS and PS. More specifically, the blend film BC had an average max stress of 6.90±1.19 MPa, which represented a 260% increase relative to the pure banana extract film (BS, 1.92±0.52 MPa). For max stress of chitosan vs BC, the two-tailed P value equals to 0.0018. This difference is considered to be very statistically significant at 95% confidence interval. For BS vs BC, the two-tailed P value equals to 0.0006. This difference is considered to be extremely statistically significant at 95% confidence interval. Similarly, the PC film had an average max stress of 6.03±0.32 MPa, which was a 173% increase compared to the original potato extract film (PS, 2.21±1.07 MPa). The differences of PC vs chitosan (two-tailed P value equals to 0.0004) and PC vs PS (two-tailed P value equals to 0.0009) are both considered extremely statistically significant at 95% confidence interval.

For the max elongation of films, the chitosan film had an average elongation of 46.97±17.59%). The extract films had average max elongation of 56.15±4.48% and 58.88±15.65% for BS and PS, respectively. Both blend films BC and PC had higher max elongations than both the chitosan and extract films (BS and PS). For the BC film, its average max elongation of 80.32±9.87% represented a 43% increase relative to the banana extract film BS (56.15±4.48%). The differences of max elongation of BC vs chitosan (two-tailed P value equals to 0.0422) and BC vs BS (two-tailed P value equals to 0.0236) are both considered statistically significant at 95% confidence interval. The same phenomenon was also apparent in the PC film, which had a 95.13±9.79% average max elongation. This was equivalent to a 62% increase in max elongation relative to the potato extract film PS (58.88±15.65%). For max elongation of chitosan vs PC, the two-tailed P value equals to 0.0054. This difference is considered to be very statistically significant at 95% confidence interval. For PS vs PC, the two-tailed P value equals to 0.0341. This difference is considered to be statistically significant at 95% confidence interval.

One possible explanation for the increase in max elongation for the blend films relative to both the chitosan and extract films is the disruption of polymer crystallinity caused by the blending of different polymers (i.e., chitosan, starch from extract), as well as the presence of other impurities in the extract. Higher crystallinity is generally associated with higher tensile strength and lower elongation in polymer films, so therefore it may be possible that blending the extract and chitosan lowers the crystallinity of the blend film, which is associated with the increased elongation. At the same time, the introduction of a higher strength polymer (i.e., chitosan) allows for the increased max stress of the blend films relative to the pure extract films (Stevens, 1990; Thakhiewet al., 2013).

In summary, blend films BC and PC showed improved mechanical properties compared to food extract films BS and PS with both higher max stress and increased max elongation.

### Water Vapor Transmission Rate

Water vapor transmission rate (WVTR) and water vapor permeability (WVP) data were obtained using a modified version of the ASTM E96/96M—16 method (ASTM, 2016). Standard 10 mL gas chromatography vials were used in the experiment, each containing 9 mL of deionized water. A hole punch was used to puncture GC vial rubber septa, effectively making rubber rings with outer and inner diameters of 19 mm and 14 mm, respectively. Another hole punch was used on the polymer films in order to make 16 mm diameter circular film shapes. The rubber rings were then placed on the GC vials (Agilent Technologies, Santa Clara, CA) and the polymer film circles were placed on top of the rings so that the films covered the entire opening of the rings, creating a seal. Standard GC vial aluminum caps (Supelco Inc., Bellefonte, PA), 9 mm in diameter, were placed on top of the vials with rubber rings and polymer films on top and were subsequently crimped. With this kind of system, water was only allowed to diffuse through the film, where the area of diffusion corresponds to the circle area of the aluminum cap opening. The vials were then placed in an HPP 260 environmentally controlled oven (Memmert USA, Eagle, WI, USA) at 23° C. and 50% relative humidity for 24 h to allow for water sorption onto the films and achieve a steady-state of mass loss over time. After the 24 h had elapsed, an initial measurement of the vial mass was taken, as well as 6 additional mass measurements across the next 120 h of the experiment. Mass loss was plotted as a function of time, and the WVTR was obtained from the slope of the obtained curve. WVP values were calculated by correcting the WVTR data with the previously determined film thickness, test temperature, and relative humidity. All reported values are the average of 3 replicates.

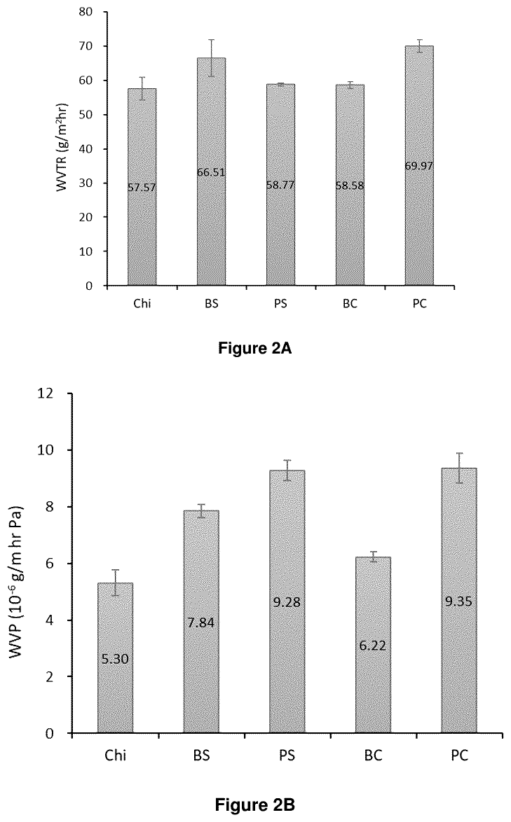

Water vapor transmission and permeability values are shown in FIG. 2. Chitosan film had water vapor transmission rate (WVTR) value of 57.57±3.37 g/m²·hr. WVTR values of extract films BS and PS were measured as 66.51±5.37 and 58.77±0.51 g/m²·hr, respectively. WVTR of both BS and PS was not statistically significant from chitosan at 95% confidence interval, the two-tailed P value equals to 0.1035 and 0.7013, respectively. Blending of extract slurry with chitosan produced opposite trends for banana and potato slurry-based films. For films containing banana extract, addition of chitosan (i.e., BC film) resulted a WVTR of 58.58±1.05 g/m²·hr and did not cause statistically significant differences at 95% confidence interval. The two-tailed P value equals to 0.1926 between BS, and BC film. Similar statistically insignificant differences were reported for chitosan film, corn starch film, and blend films (Pavoni et al., 2019). For films containing potato extract, however, addition of the chitosan (PC film, WVTR equals 69.97±1.92 g/m²·hr) resulted in statistically significant increase of the average WVTR by 16.7% vs PS film (the two-tailed P value equals to 0.0118 at 95% confidence interval). The fact that film thickness was not reflected for the calculation of WVTR of films can be a possible reason for this different trend of BC and PC films.

WVP had a somewhat different trend compared to WVTR, with the chitosan film having the lowest WVP value of (5.30±0.47)×10⁻⁶ g /m²·hr·Pa. Higher WVP value was calculated for both BS [(7.84±0.23)×10⁻⁶ g /m²·hr·Pa] and PS [(9.28±0.37)×10⁻⁶ g/m²·hr·Pa] extract films, and the differences vs chitosan film were both statistically significant (95% confidence interval, two-tailed P value equals to 0.0358 and 0.0189, respectively). Addition of the chitosan appeared to decrease diffusion of water vapor across films BC containing banana extract [(6.22±0.18)×10⁻⁶ g/m²·hr·Pa] relative to the pure banana slurry film BS by 20.7%, and the difference was statistically significant (two-tailed P value equals 0.0143 at 95% confidence interval). Similar values for WVP of banana puree films were obtained by Martelli et al. (2013), though the WVP values in this work were approximately 3-5× higher, most likely due to the much higher concentration of glycerol of the films in this work, which was known to increase water vapor permeability in both puree films and polymer films in general (Bertuzzi et al., 2007; Cao et al., 2009; Martelli et al., 2013). The WVP values of blend film BC and chitosan film are not statistically significant at 95% confidence interval (two-tailed P value equals to 0.1306), which suggests that blending chitosan film with banana slurry resulted in comparable water vapor barrier properties as the chitosan film.

The WVP value of blend film containing potato extract (PC) was (9.35±0.53)×10⁻⁶ g/m²·hr·Pa. The difference of WVP value of PC film vs PS film was not statistically significant at 95% confidence interval (two-tailed P value equals to 0.8956). The WVP value of PC film was 76.4% higher than the chitosan film (two-tailed P value equals to 0.0194). A prior study using films made from sweet potato starch showed decreases in the WVP with the addition of increasing amounts of chitosan (Shen et al., 2010). Therefore, the lower WVP of the chitosan film relative to the PS and PC was anticipated, but the lack of improvement in WVP of the PC film is somewhat unexpected. However, chitosan was added in different concentrations (0-15 g chitosan/100 g starch in the prior study vs 1 g chitosan/1 g potato extract in the current study). This may explain the lack of improvement in WVP of the PC film relative to its PS counterpart in this study, as the lower chitosan concentrations used in the sweet potato starch study may allow the chitosan to behave like a nanoparticle material. The addition of chitosan as a nanofiller to puree films has been reported to reduce the WVP. (de Barros-Alexandrino et al., 2019; Martelli et al., 2013) The concentrations of chitosan and the procedure for film preparation in the current study may result in a more porous film structure and a higher water vapor permeability.

In summary, the water vapor barrier properties of blend film BC were comparable to pure chitosan film, and the WVP results of blend film PC and food extract film PS were not statistically different. The blend films BC and PC showed improved mechanical properties without sacrifice in the water vapor barrier properties.

### ATR-FTIR

Functional group analysis was performed by using a Nicolet iS20 FTIR Spectrometer (Thermo Scientific, Waltham, MA, USA). The FTIR spectra were obtained as an average of 16 scans per sample across the 4000-400 cm⁻¹ spectral range.

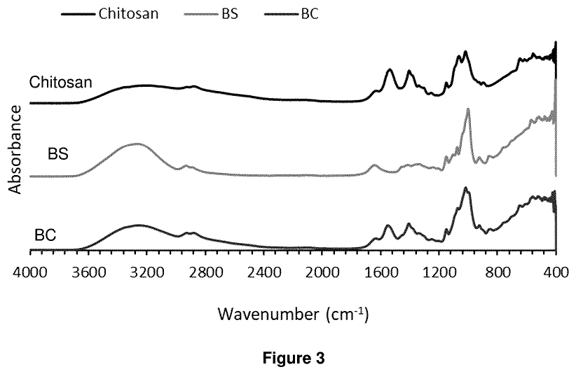

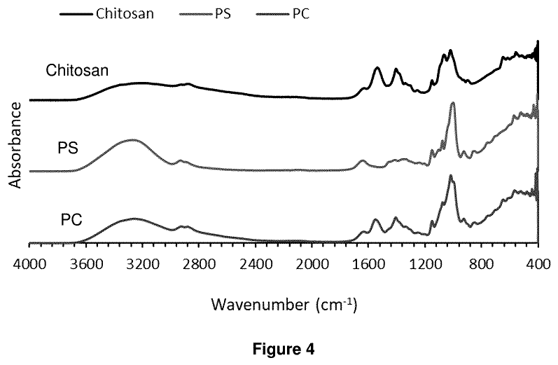

The IR spectra of these blend films were recorded to determine the changes in chemical signature due to the possible interactions between the chitosan and banana (FIG. 3) or potato (FIG. 4). The characteristic peaks of chitosan were observed in the spectra of 1:1 blend films of chitosan with banana/potato slurry films BC and PC. These peaks include O—H and N—H stretching as the broad band at 3600-3000 cm⁻¹, the C—H stretching peak at 2880 cm -1 , N—H bending at 1552 cm⁻¹, and the methylene CH2 deformation peak at 1408 cm -1 (Liu et al., 2013). The characteristic peaks of starch at 1045, 1022, and 995 cm⁻¹ (Millan-Testa et al., 2005; Sevenou et al., 2002) were also observed in the spectra of slurry films BS, PS, as well as the blend films BC and PC.

For the blend films BC and PC, a shift of N-H bending peaks was observed from 1537 cm⁻¹ (characteristic for —NH₃⁺) in the spectrum of chitosan film to 1552 cm⁻¹ (for amine group) in the spectra of blend films (Kumar-Krishnan et al., 2014). This shift of N-H bending peak towards a higher wavenumber resulted from the deprotonation of —NH₃⁺group in the blend films as well as the inter- and intra-molecular hydrogen bonding interactions between the banana/potato extract with chitosan in these blend films. Similar interactions between starches and chitosan have been reported (Liu et al., 2013; Meenakshi et al., 2002; Xu et al., 2005).

Apart from the inter- and intra-molecular hydrogen bonding interactions, no significant change of functional groups was observed from the FTIR spectra.

### Scanning Electron Microscopy (SEM)

Cross-sectional SEM imaging was done on a Phenom XL Desktop SEM (Thermo Fisher Scientific, Waltham, MA, USA). The films were cut to approximately 5 mm×1 mm samples and mounted sideways on carbon tape-covered aluminum pins, so that the cross section of the films was readily available for imaging. The films were then sputter-coated with a thin layer of gold nanoparticles and observed under a working voltage of 10 kV.

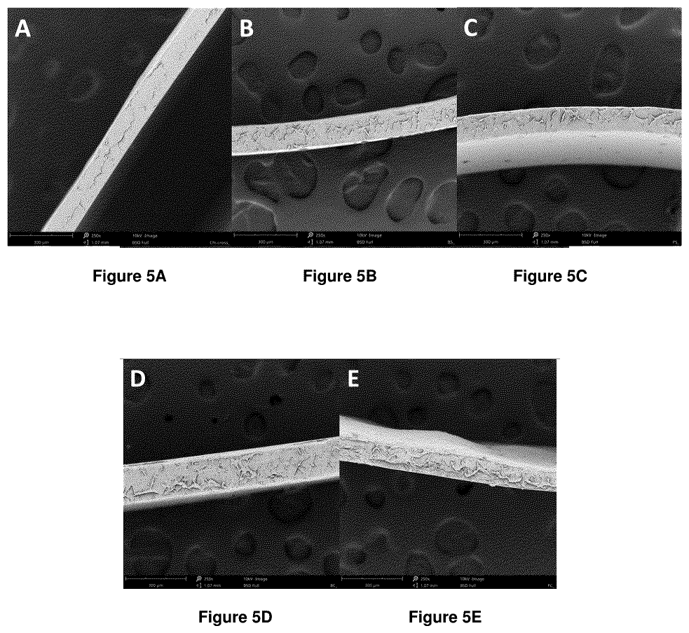

The structure of polymer blend films depends on the compatibility of individual components and the crystallinity of the overall material, which in turn is dependent on the 3-D structure of the polymer network, linearity, and side chain group affinity towards the main chain and to other side chain groups. FIG. 5 shows the cross-sectional SEM images of the biofilms discussed in this work. Generally, homogeneous and compact cross-sections are associated with more rigid films that possess a higher tensile strength, whereas an increasing porosity and a less compact cross-section usually means that the associated film is weaker, but more flexible (Zuo et al., 2019). This relationship between mechanical properties and cross-sectional SEM images is in agreement with the cross-section images of the films in this work. As shown in FIG. 5, chitosan (FIG. 5A) had the most homogeneous and compact cross-section out of all the films, which is to be expected given its relatively high tensile strength and rigidness. For extract films BS (FIG. 5B) and PS (FIG. 5C), the cross-sections showed certain discontinuous zones of porous appearance and phase separation in comparison with chitosan film (FIG. 5A). (Mathew et al., 2008) The blend films BC (FIG. 5D) and PC (FIG. 5E) films showed the highest discontinuity on their cross-sections. The PC film appeared to have a slightly more porous structure and higher level of phase separation than BC, which led to the reduced tensile strength of PC (Silva-Weiss et al., 2013), specifically the relatively lower max stress values (PC 6.03 MPa vs. BC 6.90 MPa), and relatively higher elongation at break (PC 95.13% vs. BC 77.12%). Similar non-uniform cross-section was reported by Yang et al. in 2018 for chitosan/cellulose blend films with ratio of 7:3.

In summary, phase separation and porosity were observed in the cross-section of blend films, which contributed to the improved mechanical properties of these films.

### Thermogravimetric Analysis (TGA)

Thermogravimetric analysis of the sample films was performed using a STA 449 F3 model thermal analyzer (Netzsch, Selb, GER) from room temperature to 1000° C. under nitrogen (Airgas, 99.99%, Radnor, PA, USA) with a heating rate of 5° C./min.

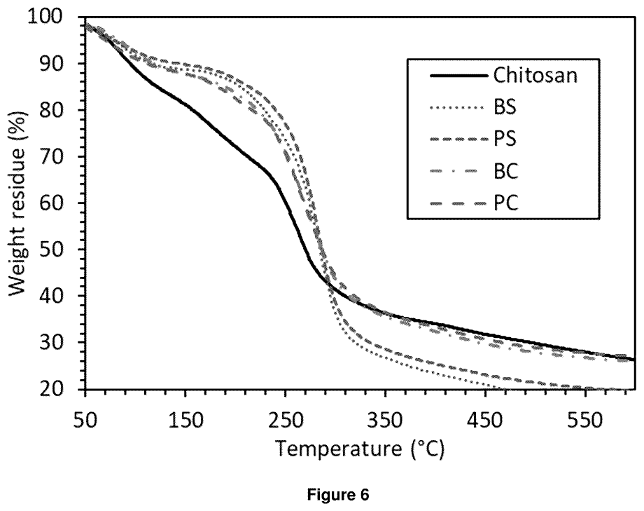

The thermal stability of the films was studied using thermogravimetric analysis (FIG. 6). The thermal degradation pattern of each film started with the loss of moisture content, which was observed as a mass loss of approximately 10% at around 120° C. in the TGA thermograms. This loss is due to loss of water content (moisture). An additional weight loss was observed at around 220° C. for the BS and PS films. For the chitosan film, the loss of moisture was followed by the decomposition of chitosan, including deacetylation and depolymerization processes, at around 220-280° C. (Guinesi et al., 2006; Kurek et al., 2012) For the two blend films (BC and PC), the 220-280° C. range of the TGA thermograms appeared as the average of the thermograms of extract film and chitosan film, with the same amount of residue (approx. 25% in mass) resulting from the decomposition of chitosan.

In summary, these films showed good thermal stability up to 200° C. prior to the decomposition of chitosan component.

### Differential Scanning Calorimetry (DSC)

DSC experiments were performed by a DSC-25 (TA Instruments, New Castle, USA) equipped with a refrigerated cooling system. The samples with mass of approximately 10 mg were sealed in aluminum hermetic pans with lids and heated in the DSC cell from −40 to 200° C. at a heating rate of 10° C./min. Dry nitrogen (Airgas, 99.99%, Radnor, PA, USA) was used as the purge gas. DSC of each film was carried out in triplicate.

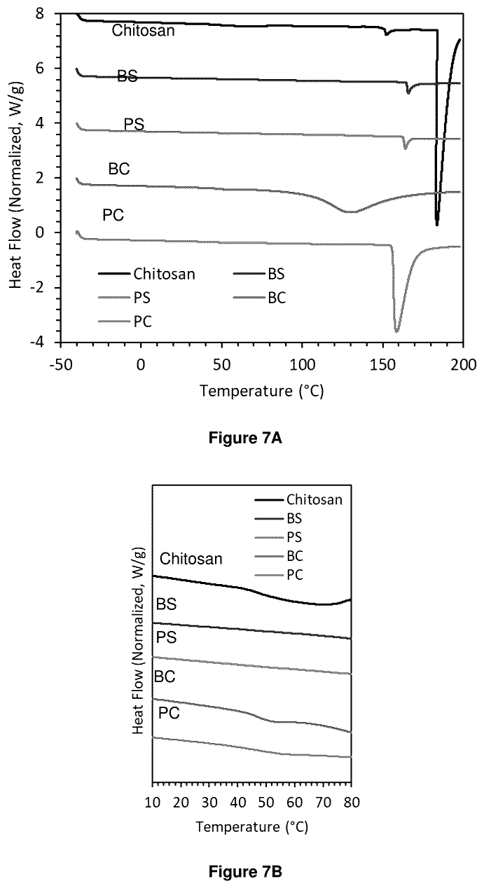

The DSC thermograms of the blend films are shown in FIG. 7A and 7B. For the chitosan film, a glass transition at 49° C. followed by two endothermic melting peaks at 152 and 181° C. were observed, with enthalpies of 3.5 and 240 J/g, respectively. The glass transition temperature and melting temperature of chitosan films was reported with a huge variation, with glass transition temperature in the range of −27 to 94° C. (Liu et al., 2013; Ma et al., 2019; Rivero et al., 2016) and melting temperature in the range of 83 to 150° C. (Cerqueira et al., 2012; Ma et al., 2019). Such variation might result from the different testing method as well as the different method in preparation of film forming solutions.

For the two slurry films (BS and PS), no visible glass transition was observed. The glass transition of films containing a large amount of starch was too weak to be detected on conventional DSC with a heating rate less than 50° C./min (Liu, et al., 2009). Additionally, polyol-plasticized films generally showed weak glass transition regions and the onset and end point were difficult to determine. For instance, Talja et al. reported in 2007 that they could not observe the glass transition for polyol-plasticized starch films stored at relative humidity of 33%-76%. The melting temperature of BS and PS films was 166 and 164° C., with melting enthalpy of 7.4 and 7.5 J/g. The glass transition temperature and melting temperature of banana puree film was reported as −44° C. and 148° C., respectively, (Martelli et al., 2013) and the glass transition temperature and melting temperature of potato starch film was reported as −24° C. and 173° C., respectively (Cyras et al., 2006; Talia et al., 2007).

For the 1:1 slurry/chitosan blend films (BC and PC), the glass transition temperature was slightly lower (47° C.) than the chitosan film (49° C.). The melting temperature of BC and PC films was reduced significantly to 129 and 159° C., respectively, compared to both the chitosan film and the extract films. The enthalpy of melting was also reduced for both blend films (198 and 163 J/g) compared to the chitosan film (240 J/g). These features indicated the well mixture of slurries and chitosan in the blend film. (Lee et al., 1996; Sudhamani et al., 2009)

In summary, the blend films showed reduced crystallinity based on the reduced melting temperature and melting enthalpy compared to the chitosan film.

### X-ray Diffraction (XRD)

Crystallinity of each film was determined via x-ray diffraction in a D8 Advance diffractometer (Bruker, Billerica, MA, USA) using nickel-filtered Cu Kα radiation at a voltage of 40 kV and 40 mA. The samples were scanned between 2θ=10-80° with a scanning speed of 0.5°·min⁻¹ as described by Shin et al. (2014) Prior to testing, film samples were stored in the controlled RH oven at 23 C and 50% RH.

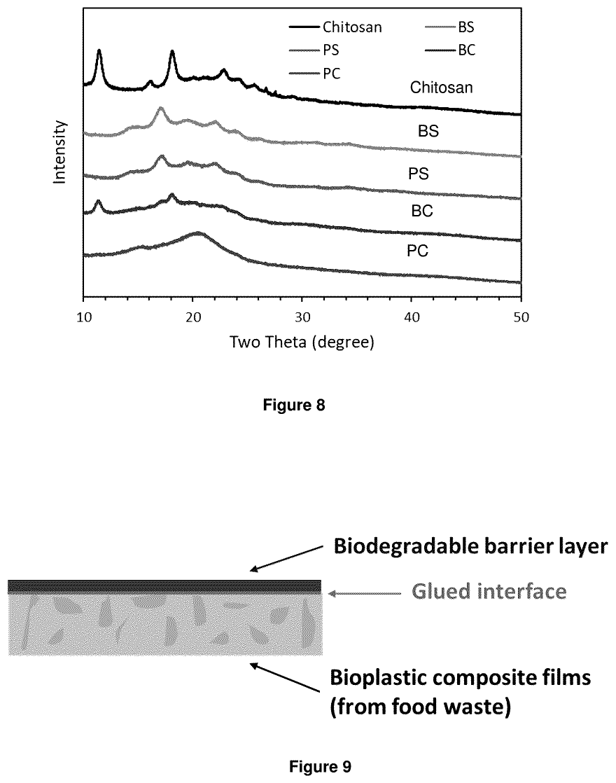

The XRD diffractograms of these blend films are shown in FIG. 8. The patterns of chitosan, BS, and PS films suggest that all three films are semicrystalline. For the chitosan film, three main reflection peaks, 2θ=11.5°, 16°, and 18°, are observed in its XRD plot, which is characteristic for chitosan/acetic acid films (Ritthidej et al., 2002). The peaks at 11.5° and 18° are assigned to the diffraction from the chitosan/acetic acid crystal planes (Kitter et al., 2003; Ma et al., 2019). Glycerol also contributed to this crystallinity via increasing chain mobility (Epure et al., 2011). Small sharp peaks as well as several broad peaks are also observed between 20-28°, indicating the existence of small crystalline regions and amorphous regions in the chitosan film.

For both slurry films BS and PS, similar pattern of sharp peaks in overlay with broad peaks are observed between 14-26°. The XRD patterns of BS and PS matched with the XRD patterns of banana starch and potato starch that are reported in literature (Lopez-Rubio et al., 2008; Pineda-Gomez et al., 2014). Both slurry films display characteristic patterns for high-amylose starches with B-type crystallinity (Buleon et al., 1998), which is consistent with the FTIR results.

For the chitosan/slurry blend films BC and PC, the XRD plots appear different from the superimposition of patterns of chitosan and extract films BS and PS. Reduced intensity of characteristic peak of chitosan (2θ=11.5°, 18° is observed in the plot of BC, while no such chitosan patterns appear in the plot of PC. For both blend films, the intensity of broad peaks in the range of 14-26° significantly increased. XRD pattern similar to PC film was reported for chitosan/corn starch 1:1 blend film (Xu et al., 2005). These XRD features are in suggestive of reduced crystallinity of the blend films (Wu et al., 2012), with PC (highly amorphous) being less crystalline than BC (approximately 10% crystalline, estimated from integral of crystalline vs amorphous peaks in XRD patterns). The reduced crystallinity indicates the good compatibility and the fine blend of chitosan with extract materials in both BC and PC films (Pawde et al., 2008). The blend of chitosan with potato slurry was slightly better than with banana slurry, which is consistent with 18.44% higher max elongation of PC film (95.13%) than that of BC (80.32%) as well as 12.61% lower max stress of PC film (6.03 MPa) than BC (6.90 MPa).

In summary, the blend films showed reduced crystallinity compared to the food extract films and pure chitosan film from XRD results.

### Statistical Analysis

Statistical analyses were performed via the use of GraphPad Analysis software (GraphPad Software, San Diego, CA, USA). A paired t-test at 95% confidence was used to determine statistically significant differences between properties of each individual film.

### Laminated Films

Use of a thin coating layer of PHB was explored to improve the WVTR of the blend film PC, which showed the highest elongation. PHB is reported to have a low WVTR value (0.5±0.08 g/hr m²) and is a commercially available bioproduct. PHB is also biodegradable in soil environments up to 79% in 105 days and in freshwater environments up to 100% in 40 days. PHB thin films were synthesized with a thickness of 16.0 μm. Test results show that their water vapor transmission rate was 0.79±0.04 g/hr m². This value is comparable to the results (0.5±0.08 g/hr m²) from Eslami et al., Biobased and compostable trilayer thermoplastic films based on poly (3-hydroxybutyrate-co-3-hydroxyvalerate)(PHBV) and thermoplastic starch (TPS) International Journal of Biological Macromolecules, 220, 385-394 (2022). Therefore, PHB was used as the coating layer to reduce the WVTR of films of the disclosure.

A series of PHB-coated PC films were synthesized. Table 2 shows their WVTR values. In table 2, AxCy references an acetic acid to chloroform ratio in the solvent mixture of x:y. For example, A1C5 is a ratio of acetic acid to chloroform of 1:5 by volume. The number of 20, 15, or 10 represents the gap of the casting knife measured by a feeler gauge blade of 20 mil, 15 mi or 10 mil, respectively. Poly[(R)-3-hydroxybutyric acid] (PHB, Aldrich, MO, USA) was first dissolved in chloroform to form a 10% w/v solution and used as a stock solution. Then, predetermined amounts of acetic acid and chloroform were added to the stock solution to get a PHB solution of 5% w/v with desired acetic acid to chloroform ratios. Each solution was used to cast on top of the PC film using a casting knife (Elcometer 3580, MI, USA) with a predetermined knife gap. The films were finally dried in the fume hood at room temperature for 24 hours. The PHB film without the PC support was prepared similarly from a 5% w/v PHB/CHCl₃ solution by casting on top of a glass plate with a knife gap of 20 mil.

TABLE 2
Summary of water vapor permeation properties and
mechanical properties of laminated PHB/PC films.

| | OVERALL | PHB LAYER | |
|---|---|---|---|
| | THICKNESS | THICKNESS | WVTR |
| SAMPLE | (MM) | (MM) | (G/HR · M²) |
| PHB | 16.0 ± 1.4 | 16.0 | 0.79 ± 0.04 |
| PHB-20- | 51.7 ± 1.2 | 17.0 | 10.60 ± 0.56 |
| A1C5 | | | |
| PHB-20- | 54.0 ± 2.9 | 20.0 | 12.17 ± 0.87 |
| A1C2 | | | |
| PHB-20- | 67.7 ± 1.2 | 21.2 | 10.43 ± 0.66 |
| A1C1 | | | |
| PHB-15- | 47.7 ± 0.5 | 9.7 | 14.50 ± 1.32 |
| A1C2 | | | |
| PHB-10- | 41.7 ± 2.6 | 5.7 | 16.00 ± 2.84 |
| A1C2 | | | |

| | | PHB | | |
|---|---|---|---|---|
| | OVERALL | LAYER | AVG. | AVG. MAX |
| | THICK- | THICK- | MAX | ELON- |
| | NESS | NESS | STRESS | GATION |
| SAMPLE | (MM) | (MM) | (MPA) | (%) |
| PHB | 16.0 ± 1.4 | 16.0 | 34.48 ± 2.22 | 1.81 ± 0.05 |
| PHB-20- | 51.7 ± 1.2 | 17.0 | 7.13 ± 0.75 | 69.14 ± 5.06 |
| A1C5 | | | | |
| PHB-20- | 54.0 ± 2.9 | 20.0 | 17.37 ± 2.16 | 19.03 ± 3.85 |
| A1C2 | | | | |
| PHB-20- | 67.7 ± 1.2 | 21.2 | 9.90 ± 0.42 | 34.66 ± 3.74 |
| A1C1 | | | | |
| PHB-15- | 47.7 ± 0.5 | 9.7 | 8.22 ± 0.67 | 48.61 ± 3.77 |
| A1C2 | | | | |
| PHB-10- | 41.7 ± 2.6 | 5.7 | 18.58 ± 1.71 | 35.90 ± 5.33 |
| A1C2 | | | | |

With a coating layer of PHB of 5.7 μm, the WVTR of the film significantly dropped from 69.97±1.92 g/hr m² to 16.00±2.84 g/hr m² of PHB-10-A1C2. With increasing thickness of the PHB layer to 9.7 μm (PHB-15-A1C2) and 20.0 μm (PHB-20-A1C2), the WVTR further decreased to 14.50±1.32 and 12.17±0.87 g/hr m², respectively. The difference in WVTR of PHB-10-A1C2 versus PHB-20-A1C2 was statistically significant (P<0.05). Then, the ratio of the casting solvent pair of acetic acid/chloroform was adjusted for PHB from 1:2 to 1:5 (PHB-20-A1C5) and 1:1 (PHB-20-A1C1), and the WVTR slightly decreased to 10.60±0.56 and 10.43±0.66, respectively (P<0.05). It is noteworthy that these laminated films all showed good transparency, as illustrated in FIG. 11.

The mechanical properties of these PHB-laminated PC films are also tested (Table 2). PHB thin film showed high max stress of 34.48±2.22 MPa and low max elongation of 1.81±0.05%. For the PHB-laminated PC films, PHB-20-A1C5 showed the highest max elongation of 69.14±5.06%, which is only 27% relatively lower than PC film (95.13±9.79%) with regard to the significant (relatively 85%) improvement in WVTR. The max elongation value reported by Eslami of the trilayer PHBV/TPS/PHBV films (3.9-13.1%) was significantly lower than that of these PHB-laminated composite films.

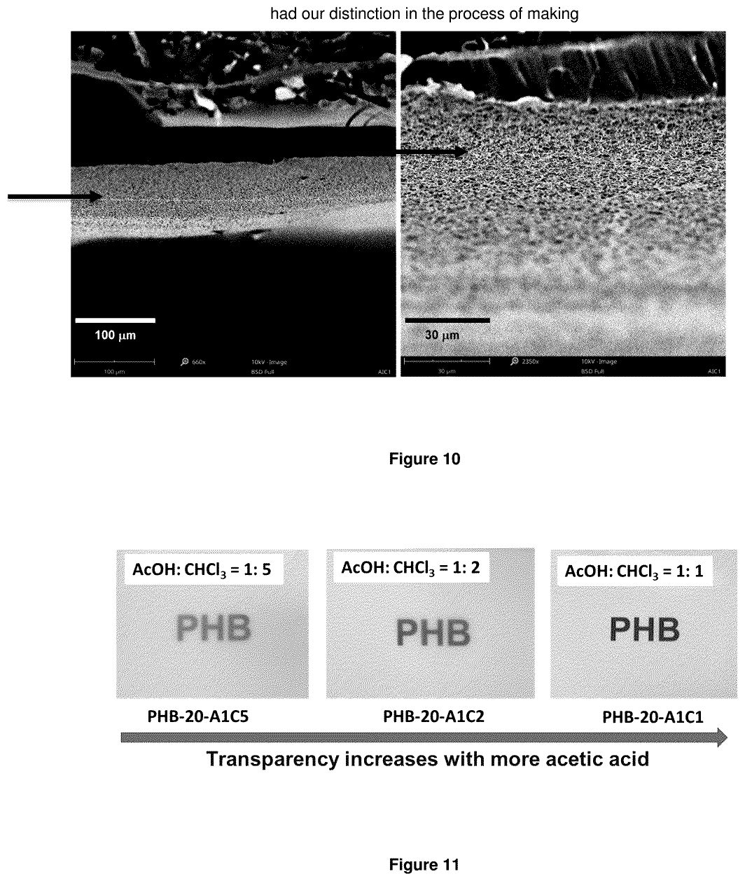

Referring to FIG. 10, cross-sectional SEM images of PHB-laminated PC films (PHB-20-A1C2) show a clear interface. Without intending to be bound by theory, it is believed that the interface results from the use of acetic acid as an adhesive between the water vapor barrier layer (PHB) and the PC film. The use of acetic acid as the adhesive was found to be effective and the laminated film showed good stability. The porous structure of the cross-section of the PHB-laminated PC film showed is apparent in the zoomed imaged of FIG. 10, which consistent with the SEM image of the PC film (FIG. 5E).

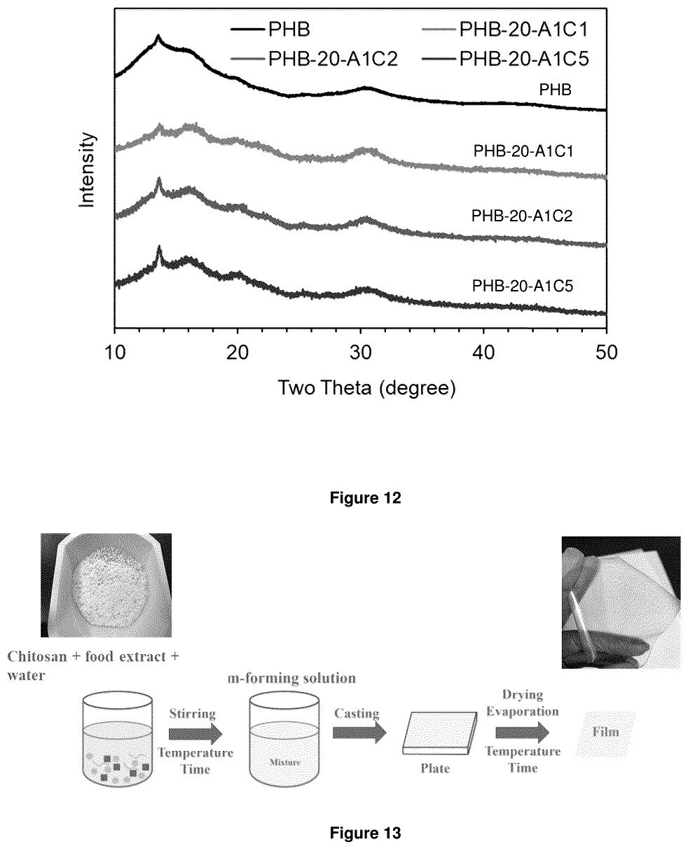

Referring to FIG. 12, the XRD diffractogram of PHB film showed three main reflection peaks at 2θ=14°, 16°, and 30° (FIG. 6b). For the PHB-laminated PC films, these reflection peaks were observed, although the intensity of 2θ=14° peak significantly decreased compared to the other two. This decrease in intensity may result from the decrease in crystallinity. PHB-20-A1C1 showed the most significant decrease, which is consistent with it being the most transparent film from the transparency test results. The increase in intensity at 2θ=20° resulted from the broad reflection peak in the range of 14-26° for PC film

### Aspects

Aspect 1. A method of forming a plastic component, comprising:
treating a polysaccharide source with an acid solution under conditions sufficient to extract the polysaccharide from the polysaccharide source, wherein the polysaccharide precipitates in the acid solution;
separating the precipitate from the acid solution;
drying the separated precipitate;
admixing the dried precipitate with water to form a slurry; and
casting or molding the slurry to form the plastic component.

Aspect 2. The method of aspect 1, wherein treating a polysaccharide source comprises treating first and second polysaccharide sources by mixing the first and second polysaccharide sources with the acid solution.

Aspect 3. The method of any one of the preceding aspects, wherein the admixture of polysaccharide source and the acid solution comprises mixing the polysaccharide source with the acid solution in an amount of about 1% w/v to about 50% w/v based on the total volume of the admixture.

Aspect 4. The method of any one of the preceding aspects, wherein the slurry comprises about 1% to about 10% w/v solution of dried precipitate to water.

Aspect 5. The method of any one of the preceding aspects wherein the polysaccharide source is starch containing food and/or food waste having a starch content of at least about 10 wt % on a dry basis.

Aspect 6. The method of aspect 5, wherein the starch containing food and/or food waste comprises one or more of banana, rice, wheat, corn peas, and potato.

Aspect 7. The method of any one of the preceding aspects, wherein the acid solution comprises one or more of citric acid, acetic acid, lactic acid, hydrochloric acid, and phosphoric acid.

Aspect 8. The method of any one of the preceding aspects, further comprising cutting the polysaccharide source into reduced sized pieces before treating with the acid solution.

Aspect 9. The method of any one of the preceding aspects, where treating with the acid solution comprises mixing the polysaccharide source with the acid solution, grinding the mixture, and storing the mixture for a time sufficient to allow the precipitates to form.

Aspect 10. The method of aspect 9, wherein the mixture is stored at a temperature of about 4° C. to about 10° C.

Aspect 11. The method of aspect 9 or 10, wherein the mixture is stored for about 5 about 24 hours.

Aspect 12. The method of any one of the preceding aspects, wherein the precipitate is dried at a temperature of about 25° C. to about 50° C.

Aspect 13. The method of any one of the preceding aspects, wherein the precipitate is dried for about 5 hours to about 24 hours.

Aspect 14. The method of any one of the preceding aspects, further comprising admixing a plasticizer into the slurry.

Aspect 15. The method of aspect 14, wherein the plasticizer is one or more of glycerol, glycerol trimester, polyglycerol, vegetable oil, and derivatives thereof.

Aspect 16. The method of any one of the preceding aspects, further comprising admixing the slurry with an amino polysaccharide solution before casting or molding the slurry.

Aspect 17. The method of aspect 16, wherein the amino polysaccharide solution comprises chitosan.

Aspect 18. The method of aspect 16 or 17, wherein the amino polysaccharide solution is mixed with the slurry in an amount of about 1% w/v to about 70% w/v based on the total volume of the slurry.

Aspect 19. The method of any one of aspects 1 to 18, further comprising coating the plastic component in a solvent mixture comprising a barrier layer coating material and drying the coated plastic component to thereby form a barrier layer coated plastic component.

Aspect 20. The method of aspect 19, wherein the solvent mixture comprises acetic acid, chloroform, and the barrier layer coating material.

Aspect 21. The method of aspect 19, wherein the acetic acid and chloroform are present in a ratio of about 1:1 to about 1:5.

Aspect 22. The method of any one of aspects 19 to 21, wherein the barrier layer coating material comprises one or more of poly(butylene succinate), collagen, polylactide, poly(caprolactone), polyglycolide, starch, cellulose, wheat gluten, and poly(3-hydroxybutyrate).

Aspect 23. A method of forming a plastic component, comprising:
treating a first polysaccharide source with an acid solution under conditions sufficient to extract the polysaccharide from the polysaccharide source, wherein the polysaccharide precipitates in the acid solution as a first precipitate;
separating the first precipitate from the acid solution;
drying the separated first precipitate;
treating a second polysaccharide source with an acid solution under conditions sufficient to extract the polysaccharide from the polysaccharide source, wherein the polysaccharide precipitates in the acid solution as a second precipitate;
separating the second precipitate from the acid solution;
drying the separated second precipitate;
admixing the dried first and second precipitates with water to form a slurry; and
casting or molding the slurry to form the plastic component.

Aspect 24. The method of aspect 23, wherein the admixture of the first polysaccharide source and the acid solution comprises mixing the first polysaccharide source with the acid solution in an amount of about 1% w/v to about 50% w/v based on the total volume of the admixture.

Aspect 25. The method of aspect 23 or 24, wherein the admixture of second polysaccharide source and the acid solution comprises mixing the second polysaccharide with the acid solution in an amount of about 1% w/v to about 50% w/v based on the total volume of the admixture.

Aspect 26. The method of any one of aspects 23 to 25, wherein the slurry comprises about 1% to about 10% w/v solution of the dried first and second precipitates to water.

Aspect 27. The method of any one of aspects 23 to 26, wherein the first and second polysaccharide sources are first and second starch containing food and/or food waste each having a starch content of at least about 10 wt % on a dry basis.

Aspect 28. The method of aspect 27, wherein the first and second starch containing food and/or food waste are independently selected from one or more of banana, rice, wheat, corn, peas, and potato.

Aspect 29. The method of aspect 28, wherein the first starch containing food and/or food waste is banana and the second starch containing food and/or food waste is potato.

Aspect 30. The method of any one of aspects 23 to 29, wherein the acid solution comprises one or more of citric acid, acetic acid, lactic acid, hydrochloric acid, and phosphoric acid.

Aspect 31. The method of any one of aspects 23 to 30, further comprising cutting the first and/or second polysaccharide sources into reduced sized pieces before treating with the acid solution.

Aspect 32. The method of any one of aspects 23 to 31, where treating the first polysaccharide source with the acid solution comprises mixing the first polysaccharide source with the acid solution, grinding the mixture, and storing the mixture for a time sufficient to allow the first precipitate to form.

Aspect 33. The method of any one of aspects 23 to 31, where treating the second polysaccharide source with the acid solution comprises mixing the second polysaccharide source with the acid solution, grinding the mixture, and storing the mixture for a time sufficient to allow the second precipitate to form.

Aspect 34. The method of aspect 32 or 33, wherein the mixture is stored at a temperature of about 4° C. to about 10° C.

Aspect 35. The method of any one of aspects 32 to 34, wherein the mixture is stored for about 5 about 24 hours.

Aspect 36. The method of any one of aspects 23 to 35, wherein the first and/or second precipitate is dried at a temperature of about 25° C. to about 50° C.

Aspect 37. The method of any one of aspects 23 to 36, wherein the first and/or second precipitate is dried for about 5 hours to about 24 hours.

Aspect 38. The method of any one of aspects 23 to 37, further comprising admixing a plasticizer into the slurry.

Aspect 39. The method of aspect 38, wherein the plasticizer is one or more of glycerol, glycerol trimester, polyglycerol, vegetable oil, and derivatives thereof.

Aspect 40. The method of any one of aspects 23 to 39, further comprising admixing the slurry with an amino polysaccharide solution before casting or molding the slurry.

Aspect 41. The method of aspect 40, wherein the amino polysaccharide solution comprises chitosan.

Aspect 42. The method of aspect 40 or 41, wherein the amino polysaccharide solution is present in the slurry in an amount of about 1 wt % to about 70 wt % based on the total weight of the slurry.

Aspect 43. The method of any one of the preceding aspects, wherein the plastic component is a film or sheet.

Aspect 44. The method of any one of aspects 23 to 43, further comprising coating the plastic component in a solvent mixture comprising a barrier layer coating material and drying the coated plastic component to thereby form a barrier layer coated plastic component.

Aspect 45. The method of aspect 44, wherein the solvent mixture comprises acetic acid, chloroform, and the barrier layer coating material.

Aspect 46. The method of aspect 45, wherein the acetic acid and chloroform are present in a ratio of about 1:1 to about 1:5.

Aspect 47. The method of any one of aspects 44 to 46, wherein the barrier layer coating material comprises one or more of poly(butylene succinate), collagen, polylactide, poly(caprolactone), polyglycolide, starch, cellulose, wheat gluten, and poly(3-hydroxybutyrate).

The foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In the case of conflict, the present description, including definitions, will control.

Throughout the specification, where the compounds, compositions, methods, and/or processes are described as including components, steps, or materials, it is contemplated that the compounds, compositions, methods, and/or processes can also comprise, consist essentially of, or consist of any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

### REFERENCES

US EPA, (2021). National Overview: Facts and Figures on Materials, Wastes and Recycling Retrieved Dec. 29, 2022, from https://www.epa.gov/facts-and-figures-about-materials-waste-and-recycling/national-overview-facts-and-figures-materials
[2] US EPA, O (2017, Sep. 12). Plastics: Material-Specific Data [Collections and Lists]. https://www.epa.gov/facts-and-figures-about-materials-waste-and-recycling/plastics-material-specific-data
[3] Geyer, R., Jambeck, J. R., & Law, K. L. (2017). Production, use, and fate of all plastics ever made. Science Advances, 3(7), e1700782. https://doi.org/10.1126/sciadv.1700782
[4] Food wastage footprint: Impacts on natural resources: summary report. (2013). FAO.
[5] Ward, C. P., Reddy, C. M. (2020). Opinion: we need better data about the environmental persistence of plastic goods. Proceedings of the National Academy of Sciences, 117(26), 14618-14621. https://doi.org/10.1073/pnas.2008009117
[6] Martelli, M. R., Barros, T. T., de Moura, M. R., Mattoso, L. H. C., & Assis, O. B. G. (2013). Effect of chitosan nanoparticles and pectin content on mechanical properties and water vapor permeability of banana puree films. Journal of Food Science, 78(1), N98—N104. https://doi.org/10.1111/j.1750-3841.2012.03006.x
[7] McHugh, T. H., Huxsoll, C. C., & Krochta, J. M. (1996). Permeability properties of fruit puree edible films. Journal of Food Science, 61(1), 88-91. https://doi.org/10.1111/j.1365-2621.1996.tb14732.x
[8] Rojas-Graü, M. A., Avena-Bustillos, R. J., Friedman, M., Henika, P. R., Martín-Belloso, O., & McHugh, T. H. (2006). Mechanical, barrier, and antimicrobial properties of apple puree edible films containing plant essential oils. Journal of Agricultural and Food Chemistry, 54(24), 9262-9267. https://doi.org/10.1021/jf061717u
[9] Wang, X., Sun, X., Liu, H., Li, M., & Ma, Z. (2011). Barrier and mechanical properties of carrot puree films. Food and Bioproducts Processing, 89(2), 149-156. https://doi.org/10.1016/j.fbp.2010.03.012
[10] Cordenunsi-Lysenko, B. R., Nascimento, J. R. O., Castro-Alves, V. C., Purgatto, E., Fabi, J. P., & Peroni-Okyta, F. H. G. (2019). The starch is (not) just another brick in the wall: the primary metabolism of sugars during banana ripening. Frontiers in Plant Science, 10, 391. https://doi.org/10.3389/fpls.2019.00391
[11] Robertson, T. M., Alzaabi, A. Z., Robertson, M. D., & Fielding, B. A. (2018). Starchy carbohydrates in a healthy diet: the role of the humble potato. Nutrients, 10(11), 1764. https://doi.org/10.3390/nu10111764
[12] USDA ERS—Food Loss. (2020). Retrieved Dec. 29, 2022, from https://www.ers.usda.gov/data-products/food-availability-per-capita-data-system/food-loss/#foodloss
[13] Mujtaba, M., Morsi, R. E., Kerch, G., Elsabee, M. Z., Kaya, M., Labidi, J., & Khawar, K. M. (2019). Current advancements in chitosan-based film production for food technology; A review. International Journal of Biological Macromolecules, 121, 889-904. https://doi.org/10.1016/j.ijbiomac.2018.10.109
[14] Pighinelli, L., Broquá, J., Zanin, B. G., Flach, A. M., Mallmann, C., Taborda, F. G. D., Machado, L. E. L., Alves, S. M. L., Silva, M. M., & Dias, R. J. S. P. (2019). Methods of chitin production a short review. American Journal of Biomedical Science & Research, 3(4), 307-314. https://doi.org/10.34297/AJBSR.2019.03.000682
[15] de Barros-Alexandrino, T. T., Tosi, M. M., & Assis, O. B. G. (2019). Comparison between chitosan nanoparticles and cellulose nanofibers as reinforcement fillers in papaya puree films: effects on mechanical, water vapor barrier, and thermal properties. Polymer Engineering & Science, 59(S1), E287-E292. https://doi.org/10.1002/pen.24938
[16] Hosseini, S. F., Rezaei, M., Zandi, M., & Farahmandghavi, F. (2015). Fabrication of bio-nanocomposite films based on fish gelatin reinforced with chitosan nanoparticles. Food Hydrocolloids, 44, 172-182. https://doi.org/10.1016/j.foodhyd.2014.09.004
[17] Melo, P. T. S., Nunes, J. C., Otoni, C. G., Aouada, F. A., & de Moura, M. R. (2019). Combining cupuassu (Theobroma grandiflorum) puree, pectin, and chitosan nanoparticles into novel edible films for food packaging applications. Journal of Food Science, 84(8), 2228-2233. https://doi.org/10.1111/1750-3841.14685
[18] Cazón, P., & Vázquez, M. (2020). Mechanical and barrier properties of chitosan combined with other components as food packaging film. Environmental Chemistry Letters, 18(2), 257-267. https://doi.org/10.1007/s10311-019-00936-3
[19] Haghighi, H., Licciardello, F., Fava, P., Siesler, H. W., & Pulvirenti, A. (2020). Recent advances on chitosan-based films for sustainable food packaging applications. Food Packaging and Shelf Life, 26, 100551. https://doi.org/10.1016/j.fps1.2020.100551
[20] Priyadarshi, R., & Rhim, J. W. (2020). Chitosan-based biodegradable functional films for food packaging applications. Innovative Food Science & Emerging Technologies, 62, 102346. https://doi.org/10.1016/j.ifset.2020.102346
[21] Xu, Y. X., Kim, K. M., Hanna, M. A., & Nag, D. (2005). Chitosan-starch composite film: preparation and characterization. Industrial crops and Products, 21(2), 185-192. https://doi.org/10.1016/j.indcrop.2004.03.002
[22] Choo, K. W., Lin, M., & Mustapha, A. (2021). Chitosan/acetylated starch composite films incorporated with essential oils: Physiochemical and antimicrobial properties. Food Bioscience, 43, 101287. https://doi.org/10.1016/j.fbio.2021.101287
[23] Mathew, S., & Abraham, T. E. (2008). Characterisation of ferulic acid incorporated starch-chitosan blend films. Food hydrocolloids, 22(5), 826-835. https://doi.org/10.1016/j.foodhyd.2007.03.012
[24] Wu, H., Lei, Y., Lu, J., Zhu, R., Xiao, D., Jiao, C., Xia, R., Zhang, Z., Shen, G., Liu, Y. & Li, S. (2019). Effect of citric acid induced crosslinking on the structure and properties of potato starch/chitosan composite films. Food Hydrocolloids, 97, 105208. https://doi.org/10.1016/j.foodhyd.2019.105208
[25] Pitak, N., & Rakshit, S. K. (2011). Physical and antimicrobial properties of banana flour/chitosan biodegradable and self sealing films used for preserving Fresh-cut vegetables. LWT-Food science and technology, 44(10), 2310-2315. https://doi.org/10.1016/lwt.2011.05.024
[26] Wang, L., Shogren, R. L., & Carriere, C. (2000). Preparation and properties of thermoplastic starch-polyester laminate sheets by coextrusion. Polymer Engineering & Science, 40(2), 499-506. https://doi.org/10.1002/pen.11182
[27] Shaikh, S., Yaqoob, M., & Aggarwal, P. (2021). An overview of biodegradable packaging in food industry. Current Research in Food Science, 4, 503-520. https://doi.org/10.1016/j.crfs.2021.07.005
[28] Eslami, H., Grady, M., & Mekonnen, T. H. (2022). Biobased and compostable trilayer thermoplastic films based on poly (3-hydroxybutyrate-co-3-hydroxyvalerate)(PHBV) and thermoplastic starch (TPS). International Journal of Biological Macromolecules, 220, 385-394.
[29] Ikejima, T., & Inoue, Y. (2000). Crystallization behavior and environmental biodegradability of the blend films of poly (3-hydroxybutyric acid) with chitin and chitosan. Carbohydrate polymers, 41(4), 351-356. https://doi.org/10.1016/S0144-8617(99)00105-8
[30] American Society for Testing and Materials. (2018). ASTM D882-18 standard test method for tensile properties of thin plastic sheeting. In Annual Book of American Standard Testing Methods.
[31] American Society for Testing and Materials. (2016). ASTM E96/E96M-16 standard test methods for water vapor transmission of materials. In Annual Book of American Standard Testing Methods.
[32] Shin, Y. H., Feridun, O. K., & Krumdick, G. (2014). Scaling Up High-Energy Cathode Materials for Electric Vehicles. Mater. Matters, 9, 131-134.
[33] Stevens, M. P. (1990). Chemical Structure and Polymer Morphology. In Polymer Chemistry (2nd ed.). Oxford University Press. ISBN: 0195057597.
[34] Thakhiew, W., Devahastin, S., & Soponronnarit, S. (2013). Physical and mechanical properties of chitosan films as affected by drying methods and addition of antimicrobial agent. Journal of Food Engineering, 119(1), 140-149. https://doi.org/10.1016/j.jfoodeng.2013.05.020
[35] Pavoni, J. M. F., Luchese, C. L., & Tessaro, I. C. (2019). Impact of acid type for chitosan dissolution on the characteristics and biodegradability of cornstarch/chitosan based films. International journal of biological macromolecules, 138, 693-703. https://doi.org/10.1016/j.ijbiomac.2019.07.089
[36] Bertuzzi, M. A., Castro Vidaurre, E. F., Armada, M., & Gottifredi, J. C. (2007). Water vapor permeability of edible starch based films. Journal of Food Engineering, 80(3), 972-978. https://doi.org/10.1016/j.jfoodeng.2006.07.016
[37] Cao, N., Yang, X., & Fu, Y. (2009). Effects of various plasticizers on mechanical and water vapor barrier properties of gelatin films. Food Hydrocolloids, 23(3), 729-735. https://doi.org/10.1016/j.foodhyd.2008.07.017
[38] Shen, X. L., Wu, J. M., Chen, Y., & Zhao, G. (2010). Antimicrobial and physical properties of sweet potato starch films incorporated with potassium sorbate or chitosan. Food Hydrocolloids, 24(4), 285-290. https://doi.org/10.1016/j.foodhyd.2009.10.003
[39] Jeevahan, J. J., Chandrasekaran, M., Venkatesan, S. P., Sriram, V., Joseph, G. B., Mageshwaran, G., & Durairaj, R. B. (2020). Scaling up difficulties and commercial aspects of edible films for food packaging: A review. Trends in Food Science & Technology, 100, 210-222. https://doi.org/10.1016/j.tifs.2020.04.014
[40] Tyagi, P., Salem, K. S., Hubbe, M. A., & Pal, L. (2021). Advances in barrier coatings and film technologies for achieving sustainable packaging of food products—a review. Trends in Food Science & Technology, 115, 461-485. https://doi.org/10.1016/j.tifs.2021.06.036
[41] Narancic, T., Verstichel, S., Reddy Chaganti, S., Morales-Gamez, L., Kenny, S. T., De Wilde, B., Babu Padamati, R. and O'Connor, K. E., 2018. Biodegradable plastic blends create new possibilities for end-of-life management of plastics but they are not a panacea for plastic pollution. Environmental science & technology, 52(18), pp.10441-10452. https://doi.org/10.1021/acs.est.8b02963
[42] Liu, H., Adhikari, R., Guo, Q., & Adhikari, B. (2013). Preparation and characterization of glycerol plasticized (high-amylose) starch-chitosan films. Journal of Food Engineering, 116(2), 588-597. https://doi.org/10.1016/j.jfoodeng.2012.12.037
[43] Millan-Testa, C. E., Mendez-Montealvo, M. G., Ottenhof, M. A., Farhat, I. A., & Bello-Perez, L.A. (2005). Determination of the molecular and structural characteristics of okenia, mango, and banana starches. Journal of Agricultural and Food Chemistry, 53(3), 495-501. https://doi.org/10.1021/jf048862x
[44] Sevenou, O., Hill, S. E., Farhat, I. A., & Mitchell, J. R. (2002). Organisation of the external region of the starch granule as determined by infrared spectroscopy. International Journal of Biological Macromolecules, 31(1-3), 79-85. https://doi.org/10.1016/S0141-8130(02)00067-3
[45] Kumar-Krishnan, S., Prokhorov, E., Ramírez, M., Hernandez-Landaverde, M.A., Zarate-Triviño, D. G., Kovalenko, Y., Sanchez, I. C., Mendez-Nonell J., & Luna-Bárcenas, G. (2014). Novel gigahertz frequency dielectric relaxations in chitosan films. Soft Matter, 10(43), 8673-8684. https://doi.org/10.1039/C4SM01804D
[46] Meenakshi, P., Noorjahan, S. E., Rajini, R., Venkateswarlu, U., Rose, C., & Sastry, T. P. (2002). Mechanical and microstructure studies on the modification of CA film by blending with PS. Bulletin of Materials Science, 25(1), 25-29. https://doi.org/10.1007/BF02704590
[47] Zuo, G., Song, X., Chen, F., & Shen, Z. (2019). Physical and structural characterization of edible bilayer films made with zein and corn-wheat starch. Journal of the Saudi Society of Agricultural Sciences, 18(3), 324-331. https://doi.org/10.1016/j.jssas.2017.09.005
[48] Silva-Weiss, A., Bifani, V., Ihl, M., Sobral, P. J. A., & Gómez-Guillén, M. C. (2013). Structural properties of films and rheology of film-forming solutions based on chitosan and chitosan-starch blend enriched with murta leaf extract. Food hydrocolloids, 31(2), 458-466. https://doi.org/10.1016/j.foodhyd.2012.11.028
[49] Yang, J., Kwon, G. J., Hwang, K., & Kim, D. Y. (2018). Cellulose-chitosan antibacterial composite films prepared from LiBr solution. Polymers, 10(10), 1058. https://doi.org/10.3390/polym10101058
[50] Guinesi, L. S., & Cavalheiro, É. T. G. (2006). The use of DSC curves to determine the acetylation degree of chitin/chitosan samples. Thermochimica Acta, 444(2), 128-133. https://doi.org/10.1016/j.tca.2006.03.003
[51] Kurek, M., Brachais, C.-H., Nguimjeu, C. M., Bonnotte, A., Voilley, A., Galić, K., Couvercelle, J.-P., & Debeaufort, F. (2012). Structure and thermal properties of a chitosan coated polyethylene bilayer film. Polymer Degradation and Stability, 97(8), 1232-1240. https://doi.org/10.1016/j.polymdegradstab.2012.05.039
[52] Ma, X., Qiao, C., Wang, X., Yao, J., & Xu, J. (2019). Structural characterization and properties of polyols plasticized chitosan films. International Journal of Biological Macromolecules, 135, 240-245. https://doi.org/10.1016/j.ijbiomac.2019.05.158
[53] Rivero, S., Damonte, L., Garcia, M. A., & Pinotti, A. (2016). An insight into the role of glycerol in chitosan films. Food Biophysics, 11(2), 117-127. https://doi.org/10.1007/s11483-015-9421-4
[54] Cerqueira, M. A., Souza, B. W., Teixeira, J. A., & Vicente, A. A. (2012). Effect of glycerol and corn oil on physicochemical properties of polysaccharide films—A comparative study. Food Hydrocolloids, 27(1), 175-184. https://doi.org/10.1016/j.foodhyd.2011.07.007
[55] Liu, P., Yu, L., Liu, H., Chen, L., & Li, L. (2009). Glass transition temperature of starch studied by a high-speed DSC. Carbohydrate Polymers, 77(2), 250-253. https://doi.org/10.1016/j.carbpol.2008.12.027
[56] Talja, R. A., Helén, H., Roos, Y. H., & Jouppila, K. (2007). Effect of various polyols and polyol contents on physical and mechanical properties of potato starch-based films. Carbohydrate polymers, 67(3), 288-295. https://doi.org/10.1016/j.carbpol.2006.05.019
[57] Cyras, V. P., Tolosa Zenklusen, M. C., & Vazquez, A. (2006). Relationship between structure and properties of modified potato starch biodegradable films. Journal of Applied Polymer Science, 101(6), 4313-4319. https://doi.org/10.1002/app.23924
[58] Lee, Y. M., Kimt, S. H., & Kimt, S. J. (1996). Preparation and characteristics of β-chitin and poly(vinyl alcohol) blend. Polymer, 37(26), 5897-5905. https://doi.org/10.1016/50032-3861(96)00449-1
[59] Sudhamani, S. R., Prasad, M. S., & Udaya Sankar, K. (2003). DSC and FTIR studies on gellan and polyvinyl alcohol (PVA) blend films. Food Hydrocolloids, 17(3), 245-250. https://doi.org/10.1016/50268-005X(02)00057-7
[60] Ritthidej, G. C., Phaechamud, T., & Koizumi, T. (2002). Moist heat treatment on physicochemical change of chitosan salt films. International Journal of Pharmaceutics, 232(1), 11-22. https://doi.org/10.1016/S0378-5173(01)00894-8
[61] Kittur, F. S., Kumar, A. B. V., & Tharanathan, R. N. (2003). Low molecular weight chitosans-preparation by depolymerization with Aspergillus niger pectinase, and characterization. Carbohydrate Research, 338(12), 1283-1290. https://doi.org/10.1016/S0008-6215(03)00175-7
[62] Epure, V., Griffon, M., Pollet, E., & Avérous, L. (2011). Structure and properties of glycerol-

plasticized chitosan obtained by mechanical kneading. Carbohydrate Polymers, 83(2), 947-952. https://doi.org/10.1016/j.carbpol.2010.09.003
[63] Lopez-Rubio, A., Flanagan, B. M., Gilbert, E. P., & Gidley, M. J. (2008). A novel approach for calculating starch crystallinity and its correlation with double helix content: A combined XRD and NMR study. Biopolymers: Original Research on Biomolecules, 89(9), 761-768. https://doi.org/10.1002/bip.21005
[64] Pineda-Gómez, P., Angel-Gil, N. C., Valencia-Muñoz, C., Rosales-Rivera, A., & Rodríguez-García, M. E. (2014). Thermal degradation of starch sources: green banana, potato, cassava, and corn-kinetic study by non-isothermal procedures. Starch-Stärke, 66(7-8), 691-699. https://doi.org/10.1002/star.201300210
[65] Buleon, A., Colonna, P., Planchot, V., & Ball, S. (1998). Starch granules: structure and biosynthesis. International Journal of Biological Macromolecules, 23(2), 85-112. https://doi.org/10.1016/S0141-8130(98)00040-3
[66] Wu, C., Peng, S., Wen, C., Wang, X., Fan, L., Deng, R., & Pang, J. (2012). Structural characterization and properties of konjac glucomannan/curdlan blend films. Carbohydrate Polymers, 89(2), 497-503. https://doi.org/10.1016/j.carbpol.2012.03.034
[67] Pawde, S. M., Deshmukh, K., & Parab, S. (2008). Preparation and characterization of poly(vinyl alcohol) and gelatin blend films. Journal of Applied Polymer Science, 109(2), 1328-1337. https://doi.org/10.1002/app.28096

What is claimed is:

1. A method of forming a plastic component, comprising:
treating a polysaccharide source with an acid solution under conditions sufficient to extract the polysaccharide from the polysaccharide source, wherein the polysaccharide precipitates in the acid solution;
separating the precipitate from the acid solution;
drying the separated precipitate;
admixing the dried precipitate with water to form a slurry; and
casting or molding the slurry to form the plastic component.

2. The method of claim 1, wherein treating a polysaccharide source comprises treating first and second polysaccharide sources by mixing the first and second polysaccharide sources with the acid solution.

3. The method of claim 1, wherein the admixture of polysaccharide source and the acid solution comprises mixing the polysaccharide source with the acid solution in an amount of about 1% w/v to about 50% w/v based on the total volume of the admixture.

4. The method of claim 1, wherein the slurry comprises about 1% to about 10% w/v solution of dried precipitate to water.

5. The method of claim 1, wherein the polysaccharide source is starch containing food and/or food waste having a starch content of at least about 10 wt % on a dry basis; optionally wherein the starch containing food and/or food waste comprises one or more of banana, rice, wheat, corn peas, and potato.

6. The method of claim 1, wherein the acid solution comprises one or more of citric acid, acetic acid, lactic acid, hydrochloric acid, and phosphoric acid.

7. The method of claim 1, further comprising admixing a plasticizer into the slurry, wherein the plasticizer is one or more of glycerol, glycerol trimester, polyglycerol, vegetable oil, and derivatives thereof.

8. The method of claim 1, further comprising admixing the slurry with an amino polysaccharide solution before casting or molding the slurry, wherein the amino polysaccharide solution comprises chitosan.

9. The method of claim 8, wherein the amino polysaccharide solution is mixed with the slurry in an amount of about 1% w/v to about 70% w/v based on the total volume of the slurry.

10. The method of claim 1, further comprising coating the plastic component by casting a solvent mixture comprising a barrier layer coating material, acetic acid, and chloroform, and drying the coated plastic component to thereby form a barrier layer coated plastic component.

11. The method of claim 10, wherein the acetic acid and chloroform are present in a ratio of about 1:1 to about 1:5.

12. The method of claim 10, wherein the barrier layer coating material comprises one or more of poly(butylene succinate), collagen, polylactide, poly(caprolactone), polyglycolide, starch, cellulose, wheat gluten, and poly(3-hydroxybutyrate).

13. The method of claim 1, wherein the plastic component is a film or sheet.

14. A method of forming a plastic component, comprising:
treating a first polysaccharide source with an acid solution under conditions sufficient to extract the polysaccharide from the polysaccharide source, wherein the polysaccharide precipitates in the acid solution as a first precipitate;
separating the first precipitate from the acid solution;
drying the separated first precipitate;
treating a second polysaccharide source with an acid solution under conditions sufficient to extract the polysaccharide from the polysaccharide source, wherein the polysaccharide precipitates in the acid solution as a second precipitate;
separating the second precipitate from the acid solution;
drying the separated second precipitate;
admixing the dried first and second precipitates with water to form a slurry; and
casting or molding the slurry to form the plastic component.

15. The method of claim 14, wherein the admixture of the first polysaccharide source and the acid solution comprises mixing the first polysaccharide source with the acid solution in an amount of about 1% w/v to about 50% w/v based on the total volume of the admixture and/or the admixture of second polysaccharide source and the acid solution comprises mixing the second polysaccharide with the acid solution in an amount of about 1% w/v to about 50% w/v based on the total volume of the admixture.

16. The method of claim 14, wherein the first and second polysaccharide sources are first and second starch containing food and/or food waste each having a starch content of at least about 10 wt % on a dry basis.

17. The method of claim 16, wherein the first starch containing food and/or food waste is banana and the second starch containing food and/or food waste is potato.

18. The method of claim 14, further comprising admixing the slurry with an amino polysaccharide solution before casting or molding the slurry, wherein the amino polysaccharide solution comprises chitosan.

19. The method of claim 14, further comprising coating the plastic component by casting a solvent mixture comprising a barrier layer coating material, acetic acid, and chloroform, and drying the coated plastic component to thereby form a barrier layer coated plastic component.

20. The method of claim 19, wherein the barrier layer coating material comprises one or more of poly(butylene succinate), collagen, polylactide, poly(caprolactone), polyglycolide, starch, cellulose, wheat gluten, and poly(3-hydroxybutyrate).
